(19) United States
(12) Patent Application Publication
(10) Pub. No.: US 2025/0325448 A1
(43) Pub. Date: Oct. 23, 2025

(54) PNEUMATIC STERILE LIQUID COMPOUNDING MACHINE

(71) Applicant: Akbar Khan, Delray Beach, FL (US)

(72) Inventor: Akbar Khan, Delray Beach, FL (US)

(21) Appl. No.: 18/888,076

(22) Filed: Sep. 17, 2024

Related U.S. Application Data
(63) Continuation-in-part of application No. 18/637,939, filed on Apr. 17, 2024, now Pat. No. 12,090,121.

(51) Int. Cl. A61J 1/20

(52) U.S. Cl. CPC A61J 1/2003

(57) ABSTRACT

In an embodiment, a user operated pneumatic sterile liquid compounding device enables a user to easily and rapidly perform a sterile liquid compounding operation. The frame of the device is configured to receive a syringe with a needle inserted into a sterile vial. A pneumatic cylinder including a pusher rod connected to a pusher plate engages the top of the syringe plunger. Initially a user-operated lever is in an “UP” position. When the lever is moved to a “DOWN” position, the device engages the pusher plate to move the plunger down to inject the liquid in the syringe into the sterile container. The compounding device is powered by pressured gas from a cartridge via an adjustable pressure regulator, a pressure release valve, and a pneumatic cylinder valve connected to the pneumatic cylinder to allow pressured gas applied to the pneumatic cylinder to raise and lower the rod.

### TECHNICAL FIELD

The technical field of the disclosed embodiments relate to sterile liquid compounding, and more particularly to user-operated liquid compounding machines.

### BACKGROUND

Liquid compounding is a crucial process in pharmaceutical and research settings, allowing for the preparation of medications and solutions tailored to specific patient needs or experimental requirements. Traditionally, this process involves manually introducing an unsterile liquid into a syringe and filtering it into a sterile vial. While feasible for small-scale operations, manual compounding becomes impractical and potentially hazardous when larger batches are required.

One significant concern with manual liquid compounding is the risk of fatigue and repetitive stress injuries among operators. Performing repetitive tasks over extended periods can lead to physical strain and discomfort, increasing the likelihood of errors and accidents. Moreover, the time and effort required for manual compounding can slow down the production process, impacting efficiency and productivity.

To address these challenges, automated liquid compounding machines have been developed. These computer-operated systems streamline the compounding process, reducing the need for manual intervention and minimizing the risk of operator fatigue and injuries. However, existing automated systems are often large, complex, and expensive, making them impractical for smaller operations such as small pharmacies, infusion clinics or research laboratories with limited resources and space.

### SUMMARY

In an embodiment, a pneumatic sterile liquid compounding device includes a frame, preferably constructed from a non-corrosive material with any crevices sealed with a sealant. The frame may include a syringe flange support configured to receive a syringe assembly. The syringe assembly may include a syringe with a barrel and a flange at a top (proximal) end, normally used for a person to grip while pressing down on a plunger to eject a liquid in the barrel. At the bottom of the syringe barrel, a hydrophilic filter may be connected to a syringe needle via a Luer lock. The syringe needle may be inserted into a sterile container. A hydrophobic vent filter including a needle may also be also inserted into the sterile container to vent gases exhausted as the liquid, e.g., an unsterilized medicine, is injected into the sterile container. The vent filter prevents bacteria from being introduced into the sterile container via the venting needle.

The syringe, including the syringe needle and vent filter needle inserted into the vial, may be positioned in the compounding device and held in place by a syringe holder that engages the flange of the syringe and a base of the frame configured to accommodate the sterile container (e.g., vial).

A pneumatic cylinder including a pusher rod may be connected to a pusher plate may engage the top of the syringe plunger. The machine may be actuated by a user-operator. Initially the lever is in an “UP” position corresponding with the pusher plate at its highest position. When moved to a “DOWN” (lowest) position, the device may engage the pusher plate to move the plunger down to inject the liquid in the syringe into the sterile container.

In operation, the compounding device is powered by pressured gas (e.g., CO2) from a cartridge via an adjustable pressure regulator, a pressure release valve, a pneumatic cylinder valve, e.g., a 4 or 5/2 way valve, connected to the pneumatic cylinder to allow pressured gas applied to the pneumatic cylinder to raise and lower the rod, and connected pusher plate between an upper position and a lower position.

An exhaust manifold may be connected to the pneumatic cylinder with a hydrophobic exhaust filter to sterilize exhausted gas.

A gauge may be connected to the pressure regulator to enable the user to observe the pressure and make adjustments as necessary.

The various filters may be, for example, 0.2 micron filters.

### BRIEF DESCRIPTION OF THE DRAWINGS

FIG. 1 is a front view of a compounding machine according to an embodiment.

FIG. 2 is a rear view of the compounding machine of FIG. 1 according to an embodiment.

FIG. 3 is a schematic diagram of the compounding machine of FIG. 1 according to an embodiment.

FIG. 4 is a schematic diagram of a compounding machine according to another embodiment.

FIG. 5 is a perspective view of a frame magnet according to an embodiment.

FIG. 6 is a perspective view of a magnetic vial holder according to an embodiment.

FIG. 7 is a perspective view of a size-reducing adapter plate according to an embodiment.

### DETAILED DESCRIPTION

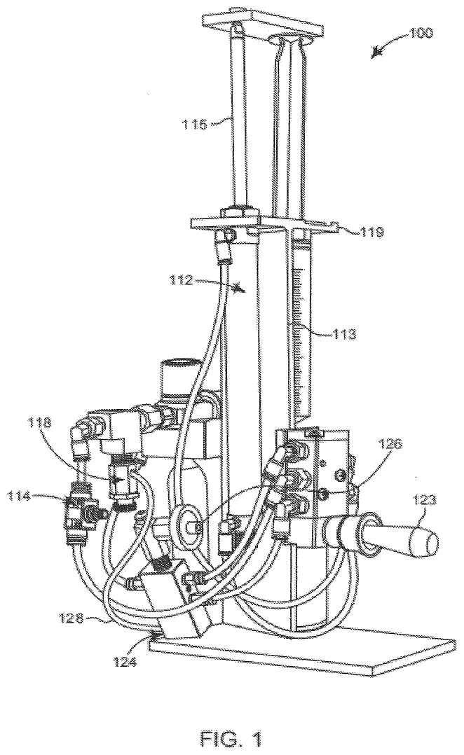

FIGS. 1, 2 and 3 show a front view, rear view, and a schematic diagram, respectively, of a compounding machine 100 designed to enable pharmacists, doctors, or other health practitioners to produce sterile liquid medications which require sterilization with a hydrophilic antimicrobial filter. The compounding machine 100 partially automates the compounding process when low volumes of sterile medications need to be produced. An advantage provided by the compounding machine 100 is the prevention of fatigue or repetitive use injury when pushing a syringe by hand to filter the liquid medication. It can also improve an individual's health and safety and increase productivity by providing a faster, more efficient workflow.

The machine 100 operates by using compressed gas to push the plunger 102 of a syringe 104 filled with an unsterile liquid medication through a hydrophilic antimicrobial filter 106, e.g., a 0.2 micron filter, fit with a suitable bore needle 107, e.g. a #21-#23 gauge needle, and into a sterile container 108, such as a sterile glass vial with a synthetic rubber cap via the bore needle 107. A hydrophobic pressure release filter 109 may include a small needle with a hydrophobic filter, e.g., 0.2 micron filter, to allow air/gas to exit the sterile container 108 when liquid is introduced into the container, and prevent bacteria from being introduced into the sterile container.

Compressed gas (e.g. CO₂) in a cartridge 110 powers the machine. A double-action pneumatic cylinder 112 is mounted in a frame, e.g., a non-corroding metal frame 113 constructed from, e.g. aluminum or stainless steel. The flow rate of compressed gas transferred to the pneumatic cylinder may be controlled by an adjustable flow control valve 114 to prevent sudden movements of a pneumatic cylinder rod 115.

The maximum pressure of gas from the gas cartridge is controlled by an adjustable gas pressure regulator 116 (e.g., relieving type, approx 0-80 psi) including a pressure gauge 117. Pressure must be set below the maximum allowable pressure for the hydrophilic antimicrobial filter 106 used to sterilize the liquid medication. A pressure relief valve 118 prevents accidental application of excess pressure to the syringe 104 and hydrophilic antimicrobial filter 106 to prevent damage (e.g. in the event of a failure of the pressure regulator).

The syringe 104 may be secured in the compounding machine by placing the flange of the syringe cylinder over a syringe holder 119. The relieving design of the pressure regulator 116 prevents excess pressure being applied to the filter if the operator manually pushes on a syringe pusher plate 120.

A pneumatic valve 121, e.g., a 4-way or 5-way/2 position type, allows pressurized gas to be applied to the pneumatic cylinder 112 to either raise or lower the syringe pusher plate. An operator-controlled lever 123 connected to the pneumatic valve 121 can be manually moved between an up and down position to mirror the up/down movement of the syringe pusher plate.

All sources of exhausted gas may be routed to an exhaust manifold 124 and passed through a hydrophobic filter 126, e.g., a 0.2 micron filter, to ensure that the exhausted gas is sterile This allows the compounding machine to be used in a sterile environment, for example, in a laminar flow hood of a biological safety cabinet, without compromising sterility. A pneumatic connecting line 128 may be connected between the pressure relief valve 118 and the exhaust manifold 124.

The compounding machine 100 preferably includes smooth, non-corroding surfaces, without crevices where bacteria can adhere. Any crevices may be filled with suitable sealant.

In an embodiment, the compounding machine 100 may first be sterilized by cleaning with a disinfectant solution, e.g. 70% isopropyl alcohol, and placed in a laminar flow hood prior to initiating a sterilized liquid compounding operation.

To prepare for a compounding operation, the operator may fill the syringe 104 (e.g. 60 ml) with an unsterile medication to be sterilized by filtration. Next, the hydrophilic antimicrobial filter 106 and the bore needle 107 may be attached to the syringe via, e.g., a Luer lock connector, forming a syringe/filter/needle assembly.

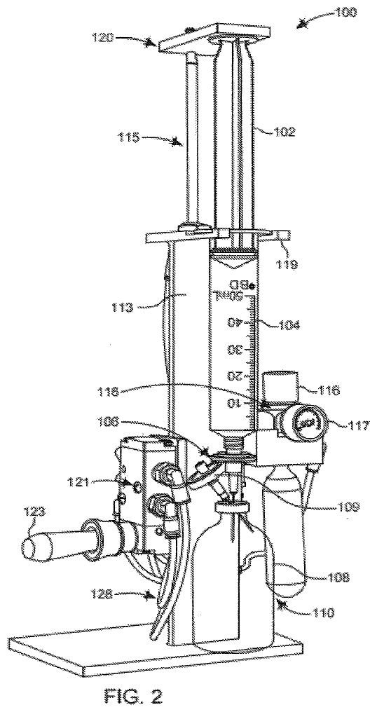

The operator inserts the bore needle 107 into the sterile container 108 and then mounts an assembly including the filled syringe, filter, and sterile container in the compounding machine 100 with the syringe pusher plate 120 in an upper (“UP”) position, i.e., with the pusher plate 120 in its highest position, as shown in FIG. 2. The operator may also insert the needle of the hydrophobic pressure release filter 109 into the container to vent air from the vial during operation.

The operator may set, or confirm that, the pressure in the compounding machine 100 is less than the maximum recommended pressure for the hydrophilic filter 106 via the pressure regulator 116 and gauge 117.

By manually operating lever 123, the operator may then set the pneumatic valve 122 to a lower position (“DOWN”) position to control the pneumatic cylinder 112 and rod 115 connected to the pusher plate 120 to lower the syringe pusher plate and push the liquid, e.g., medication, through the filter into the sterile vessel. When the contents of the syringe have passed through the filter, the operator may manually set the pneumatic valve 121 to the UP position via the lever 123 to raise the syringe pusher plate for a subsequent operation.

The syringe/filter/needle assembly and the filled container 108 may then be removed from the machine and the operation repeated as needed.

When the compressed gas cartridge 110 is empty, it can be replaced with a new cartridge.

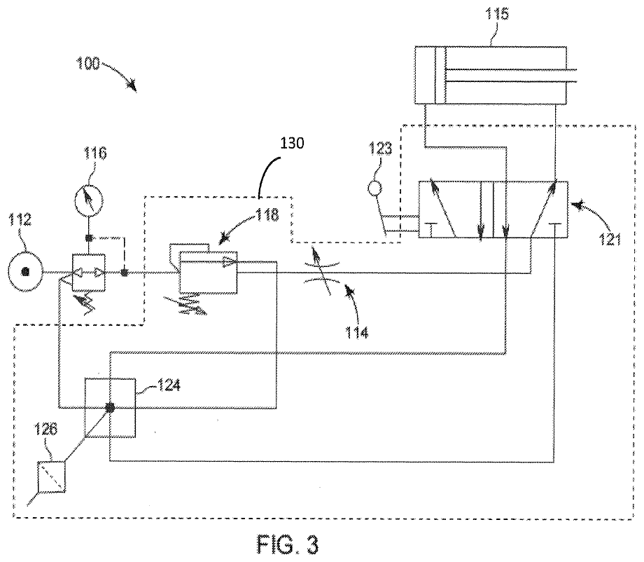

In an alternative embodiment, the compounding device may include a plastic or non-corroding metal cover 123 designed to encapsulate the tubing, relief valve, manifold, and cylinder, as shown in FIG. 3. This cover serves the purpose of facilitating sterilization procedures prior to insertion into a laminar flow hood, thereby ensuring compliance with sterilization standards. By enclosing critical components within a sterilizable casing, cleaning and sterilizing the machine 100 becomes easier to enhance operational hygiene and minimize the risk of contamination during pharmaceutical compounding processes.

In additional embodiments, the pneumatic sterile liquid compounding device may incorporate several enhancements to potentially improve functionality, safety, and versatility. These improvements build upon the core concept of the original design while addressing potential limitations and expanding capabilities.

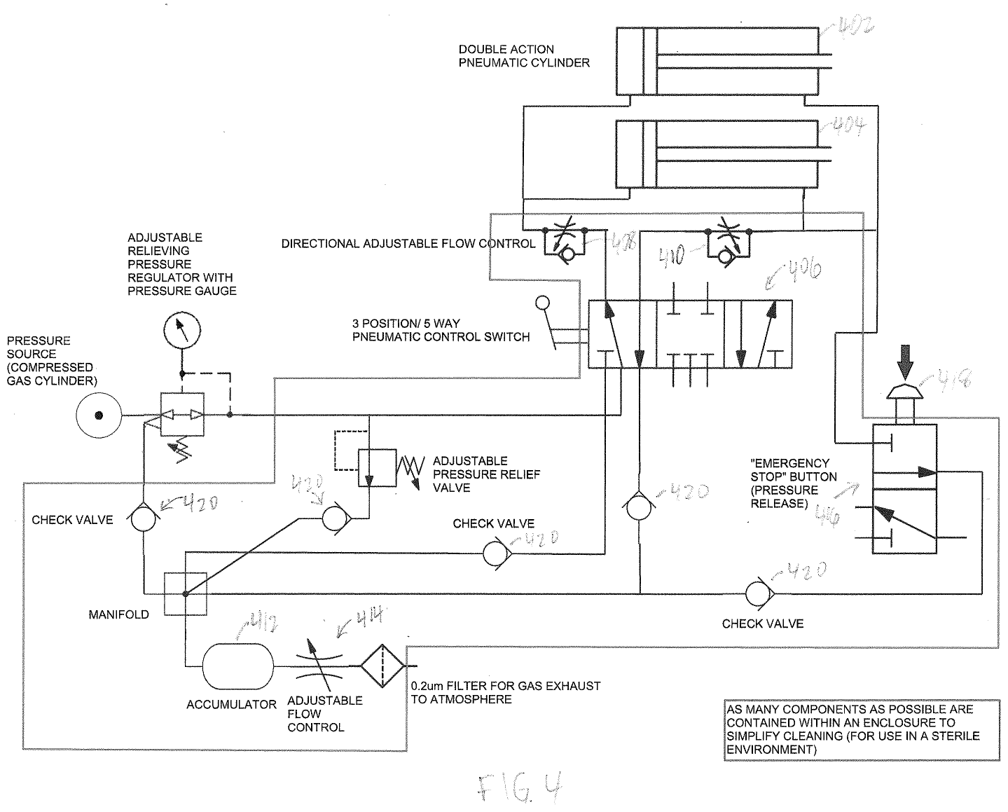

Dual Pneumatic Cylinders: In an embodiment shown in FIG. 4, the device may utilize dual pneumatic cylinders 402, 404 instead of a single cylinder. This configuration allows for increased pusher plate force without necessitating an increase in gas pressure within the pneumatic circuit. The dual cylinder design maintains the compact size of the device, which would otherwise require a single, larger diameter pneumatic cylinder to achieve comparable force. This may enable the device to handle a wider range of syringe sizes and liquid viscosities while maintaining optimal and safe operating pressures.

Enhanced Pneumatic Valve: An optional 5-way/3-position or 4-way/3-position hand-operated pneumatic valve 406 may be used instead of a 2-position valve. This valve may include a closed center position, allowing the operator to stop the pusher plate at any point during its travel. This feature is particularly useful when filling multiple vials from a single syringe, as it allows for more precise control and reduces wasted pressurized gas. For example, when filling five 10 ml vials from a 50 ml syringe, the operator can pause the pusher plate's movement between each vial fill, ensuring accurate dispensing and improved efficiency.

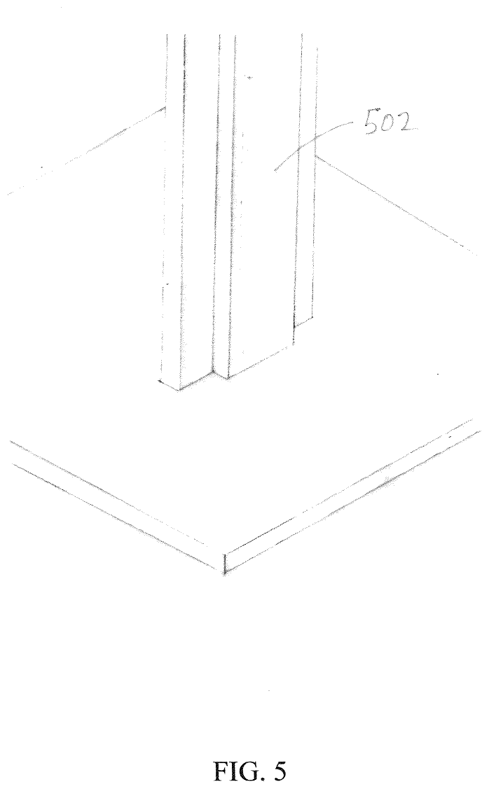

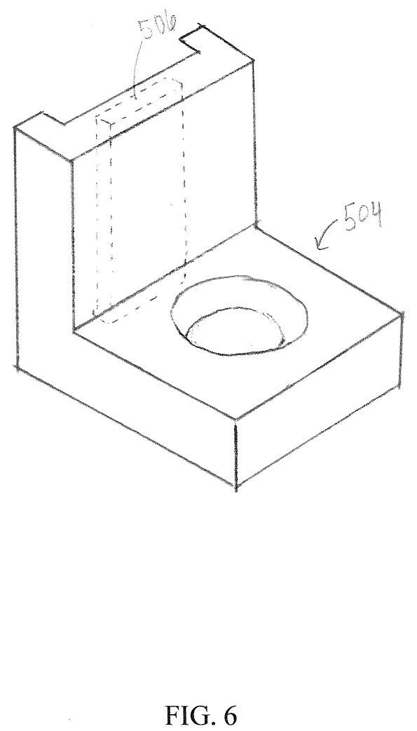

Magnetic Vial/Container Holder Device: In another embodiment shown in FIGS. 5 and 6, a magnetic vial/container holder may be incorporated into the device. This system consists of two main components:
a) a rectangular coated neodymium magnet 502 attached vertically to the front of the compounding machine frame; and
b) adapters 504 made of plastic, e.g., high density polyethylene (HDPE) (or other food-grade plastic), aluminum, or stainless steel, equipped with coated neodymium magnets 506 designed to hold various sized vials. Some adapters may include a spring clamp capable of holding an intravenous fluid bag or other vessels.

The adapter magnets 506 are polarized opposite to the frame magnet 502, creating an attraction force that allows the adapters to attach firmly to the frame while remaining removable and height-adjustable. The adapters can be positioned anywhere along the length of the frame magnet, providing flexibility for different container sizes. The coating on the magnets serves two purposes: it seals the magnets from exposure to antiseptic liquids and provides physical protection to prevent damage, as neodymium magnets are brittle and easily damaged.

Dual Directional Flow Controls: The device may incorporate dual directional flow controls 408, 410 (FIG. 4), allowing for different speeds of upward and downward pneumatic cylinder rod movement. This feature provides greater control over the compounding process, enabling operators to optimize the speed for different stages of the operation, such as faster retraction of the pusher plate and slower, more controlled dispensing of the liquid.

Pressure Vessel and Flow Control Device: A pressure vessel (accumulator) 412 and flow control device 414 may be installed between the manifold and the filter. This addition acts as a buffer to prevent sudden pressure changes from rupturing the 0.2 μm exhaust filter. The accumulator absorbs pressure fluctuations, ensuring a more stable and consistent pressure throughout the system to maintain the integrity of the delicate filter membrane.

Emergency Pressure Release Feature: To enhance safety, particularly in case a finger gets pinched under the pusher plate, an emergency pressure release feature may be incorporated. This feature consists of a detent push/pull pneumatic valve 416 with a highly visible and low actuation force push button 418, typically designed as a red, mushroom-shaped button. When pressed, this button rapidly releases the gas pressure from the pneumatic cylinders. The button is resettable by pulling it up to its original position, allowing for quick resumption of operation after addressing the safety concern.

Check Valves: The pneumatic circuit may be equipped with check valves 420 to prevent the reverse flow of exhausted gas. This addition enhances the overall efficiency of the system and allows the system to maintain operation according to design, even in conditions that would be rarely encountered, such as failure of one of the pneumatic components. For example, check valves will prevent the pusher plate from moving in the event of a failure of the adjustable pressure regulator and activation of the pressure relief valve.

Lubrication and Sealant Specifications: To maintain the highest standards of cleanliness and compatibility with pharmaceutical applications, food-grade FDA or NSF certified lubricants may be used in the pneumatic cylinders and pneumatic valve. Similarly, any crevices in the device which may be difficult to keep clean and free of bacteria may be filled with food-grade FDA or NSF certified sealant. These specifications ensure that the device remains suitable for use in sterile environments and complies with relevant regulatory standards.

Sterile Compressed Gas Option: The compressed gas cylinders that drive the machine may be specified as sterile. This option allows for gas cylinder changeover in a sterile environment, which is particularly useful in situations where a cylinder runs out of gas while operating the machine in a clean room or laminar flow hood. Any gas that leaks out from the cylinder while it is being attached to or detached from the machine will not contaminate the sterile environment, maintaining the integrity of the compounding process.

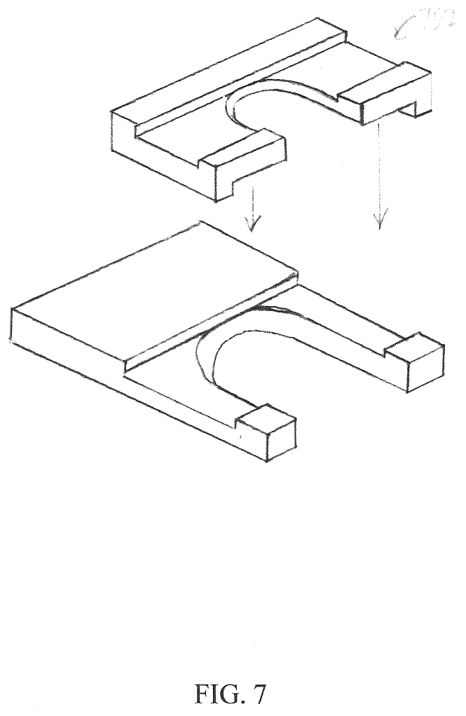

Size-Reducing Adapter Plates: To accommodate various syringe sizes, the device may include size-reducing adapter plates 702 (FIG. 7) that can be placed on the syringe holder. While the main syringe holder is typically designed for 50 cc or 60 cc syringes, these adapter plates allow for the use of smaller syringes, such as 10 cc, 20 cc, or 30 cc sizes. This feature increases the versatility of the device, allowing it to handle a wider range of compounding volumes without compromising stability or accuracy.

Pressure Calculation Tables: Recognizing that the pressure applied to the syringe piston and hydrophilic antimicrobial filter is not necessarily equal to the pressure of compressed gas in the pneumatic circuit as shown on the pressure gauge, the device may be supplied with pre-calculated tables. These tables guide the user in selecting the optimal pressure to be applied to the disc filter which is high enough for rapid liquid sterilization but below the maximum allowed for the filter. For example, a table might indicate that the pressure regulator should be set to X psi in order to achieve a pressure of Y psi at the disc filter, for a syringe with a plunger diameter of A millimeters and a disc filter with a diameter of B millimeters. This feature ensures accurate and safe operation across various syringe and filter combinations, reducing the risk of filter damage or inefficient filtration.

The foregoing method descriptions and figures are provided as illustrative examples only. The order of operations in the aspects described herein may be performed in one or more other orders. Words such as “thereafter,” “then,” “next,” etc. are used to guide the reader through the description of the methods and systems described herein, and do not limit the order of the operations. Any reference to claim elements in the singular, for example, using the articles “a,” “an,” or “the” is not to be construed as limiting the element to the singular. Also, relative terms such as “top,” “bottom,” “upper,” “lower,” “up”, “down”, “above,” “below,” and the like as used herein describe the relative positions of elements or features, and are not limited to the orientations depicted in the drawings. As used herein, the terms “user” and “operator” are interchangeable. Furthermore, the specific dimensions and other details set forth with regard to specific embodiments are for illustrative purposes only and are not intended to limit the scope of the claims.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the specific embodiments described herein but is to be accorded the widest scope consistent with the claims.

1. A liquid compounding device comprising:
a frame including a syringe flange support configured to receive a syringe assembly including a syringe with a barrel and a flange at a distal end and a proximal end, a filter connected to the end of the barrel and connected to a syringe needle, and a container, wherein the syringe needle is inserted into the container;
a base configured to support the container;
a pneumatic cylinder;
a rod connected to the pneumatic cylinder;
a pusher plate connected to the rod;
a pressure regulator;
a pressure release valve connected to the pressure regulator;
a cartridge connector connected between the pneumatic cylinder and the pressure regulator, the cartridge connector configured to allow a cartridge containing a pressurized gas to be removably connected;
a pneumatic cylinder valve connected to the pneumatic cylinder, said valve operative to allow pressurized gas applied to the pneumatic cylinder to raise and lower the rod;
a pneumatic cylinder valve control switch operative to control the pneumatic cylinder to move the rod and connected pusher plate between an upper position and a lower position;
a manually operated lever connected to the pneumatic cylinder valve and configured to enable an operator to control the rod between the upper position and the lower position; and
an exhaust manifold connected to the pneumatic cylinder.

2. The liquid compounding device of claim 1, further comprising dual pneumatic cylinders configured to increase pusher plate force without increasing gas pressure within the pneumatic circuit.

3. The liquid compounding device of claim 1, wherein the pneumatic cylinder valve is a 5-way/3-position or 4-way/3-position hand-operated pneumatic valve with a closed center position, allowing the operator to stop the pusher plate at any point during its travel.

4. The liquid compounding device of claim 1, further comprising a magnetic vial/container holder device including:
a rectangular coated neodymium magnet attached vertically to the frame; and
adapters equipped with coated neodymium magnets designed to hold various sized vials or containers.

5. The liquid compounding device of claim 1, further comprising dual directional flow controls allowing for different speeds of upward and downward pneumatic cylinder rod movement.

6. The liquid compounding device of claim 1, further comprising a pressure vessel and flow control device installed between the exhaust manifold and an exhaust filter, configured to absorb pressure fluctuations.

7. The liquid compounding device of claim 1, further comprising an emergency pressure release feature including a detent push/pull pneumatic valve with a highly visible and low actuation force push button.

8. The liquid compounding device of claim 1, further comprising check valves in the pneumatic circuit to prevent reverse flow of exhausted gas.

9. The liquid compounding device of claim 1, wherein the pneumatic cylinder and pneumatic valve use food-grade FDA or NSF certified lubricants.

10. The liquid compounding device of claim 1, wherein the cartridge connector is configured to connect to a sterile compressed gas cylinder.

11. The liquid compounding device of claim 1, further comprising size-reducing adapter plates configured to accommodate syringes of various sizes.
